(19) United States
(12) Patent Application Publication
(10) Pub. No.: US 2025/0205115 A1
(43) Pub. Date: Jun. 26, 2025

(54) MEDICINE SUPPLY MODULE AND MEDICINE PACKING APPARATUS INCLUDING SAME

(71) Applicants: Youngtae KIM, Seoul (KR); Sang Hwan JANG, Seoul (KR)

(72) Inventors: Youngtae KIM, Seoul (KR); Sang Hwan JANG, Seoul (KR)

(73) Assignee: KISAN ELECTRONICS CO., LTD., Seoul (KR)

(21) Appl. No.: 18/928,272

(22) Filed: Oct. 28, 2024

(30) Foreign Application Priority Data
Dec. 21, 2023 (KR) 10-2023-0188399

(51) Int. Cl. A61J 7/00; A61J 3/00

(52) U.S. Cl. CPC A61J 7/0084; A61J 3/00

(57) ABSTRACT

Disclosed are a medicine supply module and a medicine packing apparatus including the same. The disclosed medicine supply module includes a canister having an internal space adapted to accommodate a medicine, an insertion hole through which the medicine enters the internal space, and a discharge hole through which the medicine is discharged from the internal space; a rotor that rotates in the internal space to discharge the medicine one tablet at a time through the discharge hole; a cassette frame that supports the canister at an angle such that a first side of the canister is lower than a second side of the canister; and an electric motor that provides power to rotate the rotor and is supported by the cassette frame. The insertion hole is on the first side, and the discharge hole is on the second side of the canister.

### CROSS REFERENCE TO PRIOR APPLICATION

This application claims the benefit of Korean Patent Application No. 10-2023-0188399, filed on Dec. 21, 2023, which is hereby incorporated by reference as if fully set forth herein.

### BACKGROUND

### Field of the Invention

The present invention relates to a medicine packing apparatus for automatically packing a medicine, and more specifically, to a medicine supply module for dispensing a medicine such that one tablet falls at a time, and a medicine packing apparatus including the medicine supply module.

### Discussion of the Related Art

In general, a medicine packing apparatus refers to an apparatus for automatically packing a medicine prescribed for a patient's illness or condition on a dose basis, and is primarily used in large hospitals or pharmacies.

The medicine packing apparatus includes a medicine cassette configured to store medicine tablets or capsules and dispense the medicine tablets or capsules one tablet or capsule at a time to fall toward a hopper according to an input prescription. To store various types of medicines by type, a plurality of medicine cassettes are in a matrix in the medicine packing apparatus, resembling a bookshelf.

The medicine packing apparatus may include a plurality of cassette decks arranged vertically to form a plurality of layers and support the plurality of medicine cassettes in a matrix form. The medicine cassettes may be detachably coupled to the cassette decks. Because the medicine cassette is vertical with respect to the cassette deck, to be separated from or mounted on the cassette deck, the distance between a lower cassette deck and an upper cassette deck in two different layers needs to be greater than the height of the medicine cassette. Thus, there is a problem of difficulty in reducing the size of the medicine packing apparatus.

In addition, because the medicine cassette needs to be separated from the cassette deck when replenishing the medicine cassette with a medicine, the operation of the medicine packing apparatus needs to be stopped when replenishing the medicine cassette. Thus, there is a problem of delay in a medicine packing task.

The background art for the present disclosure is disclosed in Korean Patent Publication No. 10-2018-0106094 (published on Oct. 1, 2018, and entitled “Tablet cassette for providing sample tablets and automatic tablet dispenser using same”).

### SUMMARY

The present disclosure has been created to solve the above problems, and aims to provide a medicine supply module including a canister that is inclined and detachably mounted on a cassette frame, and a medicine packing apparatus including the medicine supply module.

To achieve these objects and other advantages and in accordance with the purpose(s) of the invention, as embodied and broadly described herein, a medicine supply module of the present disclosure includes a canister having an internal space adapted to accommodate a medicine, an insertion hole through which the medicine enters the internal space, and a discharge hole through which the medicine is discharged from the internal space, the insertion hole being on a first side of the canister and the discharge hole being on a second side of the canister opposite from the first side; a rotor in the internal space configured to rotate and discharge the medicine one tablet at a time through the discharge hole; a cassette frame that supports the canister at an angle such that the second side of the canister is lower than the first side of the canister; and an electric motor that provides power to rotate the rotor and is supported by the cassette frame.

In another aspect of the present invention, a medicine packing apparatus comprises a medicine cabinet comprising a plurality of the medicine supply modules in a matrix, and a rear frame that supports the plurality of medicine supply modules; and a packing unit that packs the medicine discharged from the medicine cabinet on a dose basis.

In a medicine supply module of the present disclosure, the canister may move in an inclination direction and be detachably coupled to the cassette frame, and the cassette frame is detachably coupled to another cassette frame of an adjacent (and optionally identical) medicine supply module. Thus, the vertical height and the horizontal width of the medicine packing apparatus including a plurality of the medicine supply modules in the matrix may be reduced.

In other words, compared to a conventional medicine packing apparatus with the same number of types of medicines to be automatically supplied, the medicine packing apparatus of the present disclosure may be more compact, enabling installation in a smaller space.

According to an embodiment of the present disclosure, the canister may be supplied and replenished with a medicine while the canister is mounted on the cassette frame. Accordingly, the canister may be supplied and replenished with the medicine without stopping the operation of the medicine packing apparatus, and thus, the productivity of medicine packing tasks may be improved.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a front view of a medicine packing apparatus according to an embodiment of the present disclosure;

FIG. 2 is a side view of a medicine packing apparatus according to an embodiment of the present disclosure;

FIG. 3 is a perspective view of a medicine supply module according to an embodiment of the present disclosure, as viewed from above;

FIG. 4 is a perspective view of the medicine supply module of FIG. 3, as viewed from below;

FIG. 5 is a cross-sectional view of the medicine supply module of FIG. 3, taken along line V-V;

FIG. 6 is a cross-sectional view of the medicine supply module of FIG. 3, taken along line VI-VI;

FIG. 7 is an exploded perspective view of the medicine supply module of FIG. 3, as viewed from the front;

FIG. 8 is an exploded perspective view of the medicine supply module of FIG. 3, as viewed from the rear;

FIG. 9 is an enlarged perspective view of the canister shown in FIG. 7;

FIG. 10 is an enlarged perspective view of the rotor shown in FIG. 7; and

FIG. 11 is an enlarged perspective view of the circuit board and the light guide shown in FIG. 7.

### DETAILED DESCRIPTION

Hereinafter, a medicine supply module and a medicine packing apparatus including the same according to one or more embodiments of the present disclosure will be described in detail with reference to the accompanying drawings. The thicknesses of lines or the sizes of components may be shown as exaggerated in the drawings, for the clarity and convenience of description. Further, the terms as set forth herein are defined in consideration of functions in the present invention, and they may be different according to the intent of an operator or customs. Accordingly, the terms should be defined based on the overall contents of the present disclosure.

Hereinafter, a medicine supply module and a medicine packing apparatus including the same according to one or more embodiments of the present disclosure will be described in detail with reference to the accompanying drawings. The terms used in the present specification are for appropriately describing preferred embodiments of the present disclosure, and may vary depending on the intention of a user or an operator, or precedents of the field to which the present disclosure belongs. Therefore, the definitions of these terms should be based on the description throughout the present specification.

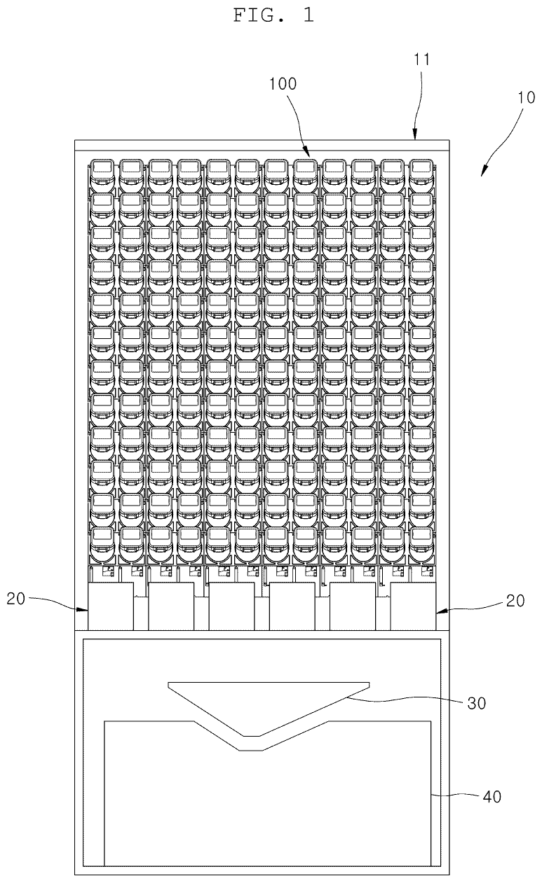

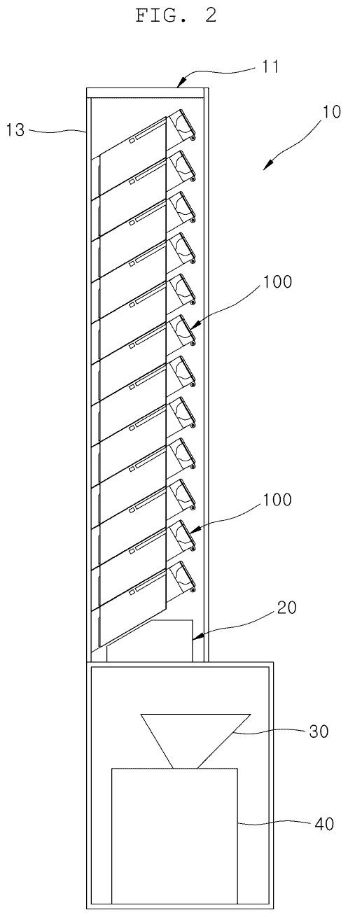

Referring to FIGS. 1 and 2, a medicine packing apparatus 10 according to one or more embodiments of the present disclosure is an apparatus for automatically packing a medicine on a dose basis according to a prescription or an instruction input by a user.

The medicine packing apparatus 10 includes a medicine cabinet 11, a hopper 30, and a packing unit 40. The medicine cabinet 11 includes a plurality of medicine supply modules 100 in a matrix, and a rear frame 13 that supports the plurality of medicine supply modules 100. The rear frame 13 is perpendicular to a horizontal line or plane PL. The plurality of medicine supply modules 100 may be detachably coupled to and supported by the rear frame 13.

The packing unit 40 continuously packs the medicine dispensed from the medicine cabinet 11 on a dose basis. The packing unit 40 may be below the medicine cabinet 11. The hopper 30 is between the medicine cabinet 11 and the packing unit 40. The hopper 30 collects the medicine that has fallen from a specific medicine supply module 100 among the plurality of medicine supply modules 100 in the medicine cabinet 11, and directs the collected medicine to the packing unit 40.

The medicine packing apparatus 10 may further include a plurality of multi-type medicine supply devices 20 between the hopper 30 and the medicine supply module 100, in the lowermost layer among the plurality of medicine supply modules 100. When a specific medicine that is not stored in the plurality of medicine supply modules 100 is included in a single dose of a prescribed medicine, the user of the medicine packing apparatus 10 may supply the specific medicine to the hopper 30 through the multi-type medicine supply device(s) 20. This multi-type medicine supply device 20 can supply multiple types of medicines, while the medicine supply module 100 supplies one specific type of medicine.

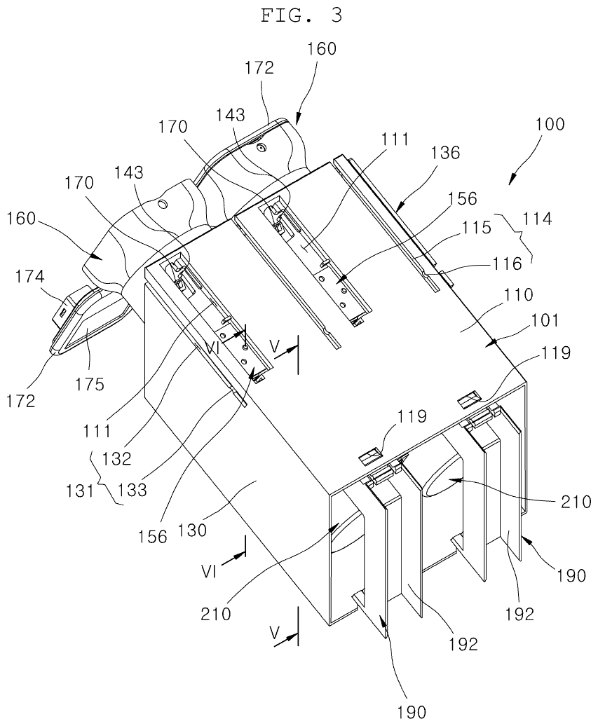

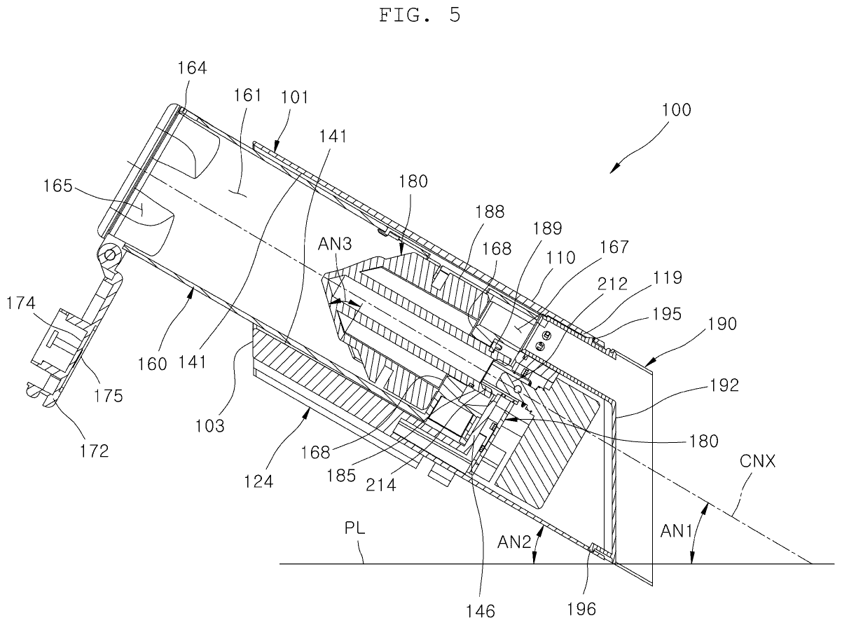

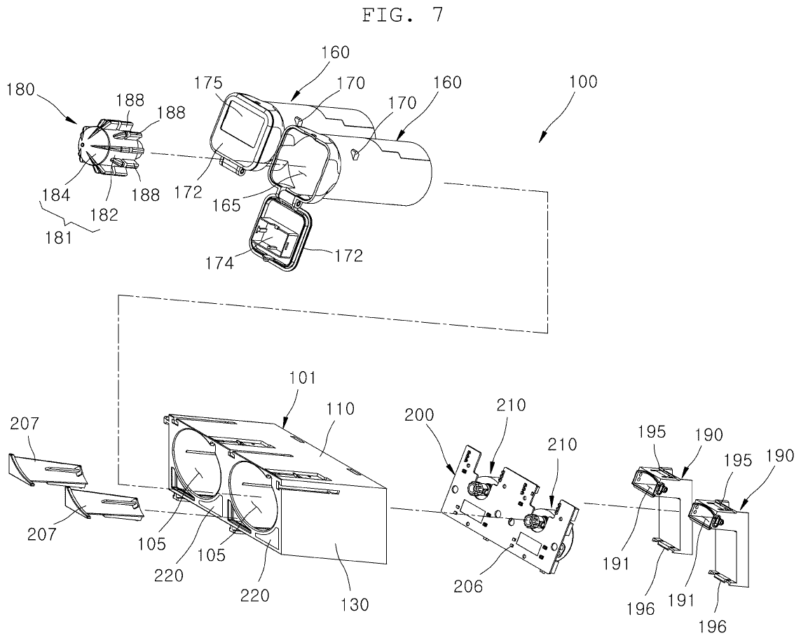

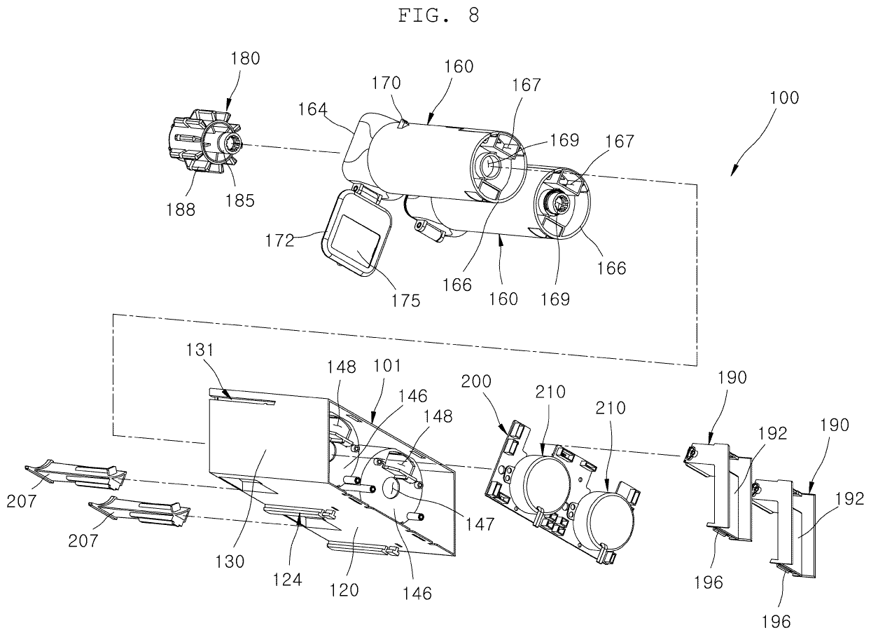

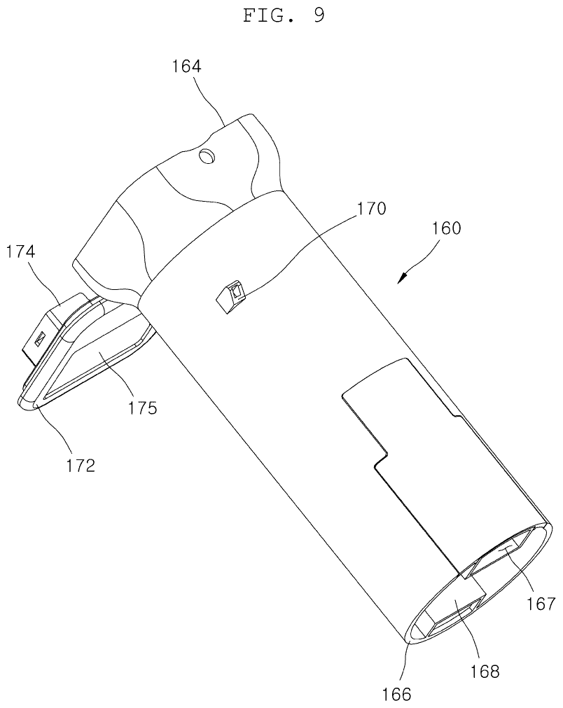

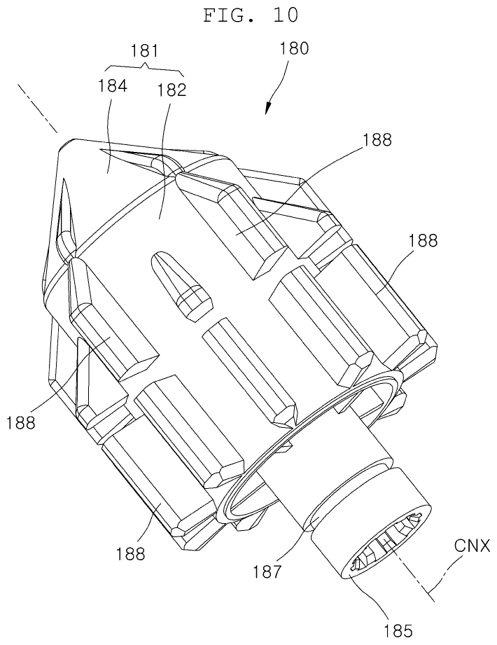

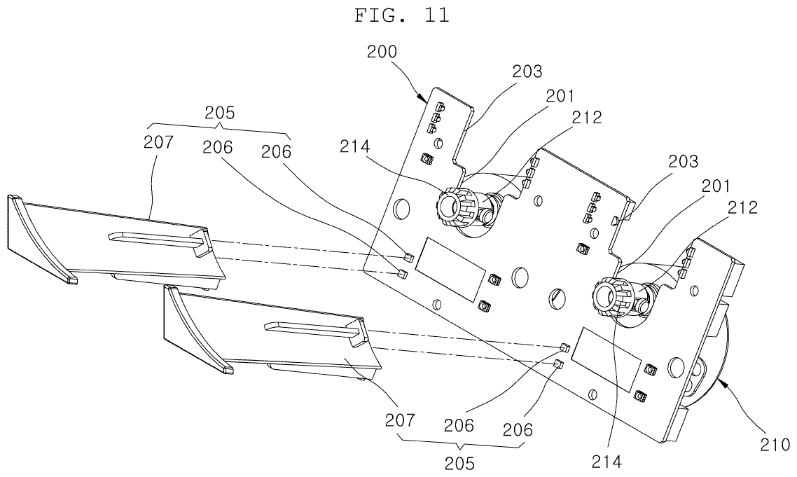

Referring to FIGS. 3 to 11, the medicine supply module 100 according to one or more embodiments of the present disclosure includes a cassette frame 101, a canister 160, a rotor 180, and an electric motor 210. The canister 160 is a unit having an internal space 161 adapted to accommodate a medicine. An insertion hole 165 through which the medicine enters the internal space 161, and a discharge hole 167 through which the medicine is discharged from the internal space 161 are on first and second opposite sides or ends of the canister 160, respectively.

The first side or end and the second side or end of the canister 160 may be, for example, a front or upper end 164 and a rear or lower end 166 of the canister 160, respectively. A cap 172 adapted to open and close the insertion hole 165 may be at the front end 164 of the canister 160. The cap 172 may be hingedly coupled to the front end 164 of the canister 160 to open and close the insertion hole 165. The canister 160 may comprise formed of a material having a transparency sufficient to allow the medicine in the internal space 161 to be roughly identified with the naked eye from the outside without opening the cap 172. The canister 160 and the front end may independently have a portion with a quadrangular column shape with rounded corners, and another portion with a cylindrical shape. Alternatively, the canister 160 and/or the front end may have a cylindrical shape in its entirety.

A label attachment surface 175 to which a label (not shown) for indicating, for example, the type of the medicine in the internal space 161 of the canister 160 may be attached, may be provided on one side of the cap 172 that is exposed forward when the insertion hole 165 is closed.

The other side of the cap 172 may have a moisture removal agent installation portion 174 thereon, configured to contain a moisture removal agent to remove moisture from the internal space 161 and prevent deterioration of the medicine stored in the internal space 161. The medicine stored in the canister 160 may be in the form of tablets or capsules.

The rotor 180 is in the internal space 161, on the second side or the rear end 166 of the canister 160. The rotor 180 includes a core 181, a connecting shaft portion 185, and a plurality of blades 188. The core 181 may include a cylindrical portion 182 having a cylindrical shape, and a conical portion 184 connected to the front end (or the top portion) of the cylindrical portion 182.

The conical portion 184 may be tapered such that its diameter decreases toward the front. An inclination angle AN3 of the conical portion 184 may be about 40° to about 50°. The inclination angle AN3 of the conical portion 184 may be defined as the angle between a cone inclination line connecting the apex of the conical portion 184 to a base edge of the conical portion 184, and an imaginary line in the radial direction perpendicular to a canister axis line CNX. The inclination angle AN3 allows the medicine to be inserted between the blades 188 and discharged to the outside (e.g., outside of the canister 160) via the surface of the rotating conical portion 184 in the internal space 161 of the inclined canister 160. When the conical portion 184 is at an angle outside the above-described range of the inclination angle AN3, the discharge of the medicine may not be seamless.

The connecting shaft portion 185 may protrude backward from the core 181 (e.g., toward the rear frame 13). A rotor axis line extending inside the internal space 161 in the lengthwise direction of the core 181 and the connecting shaft portion 185 may coincide with the canister axis line CNX extending in the lengthwise direction of the canister 160. The rotor 180 may rotate around the canister axis line CNX. However, it is obvious that the rotor axis line and the canister axis line CNX may not coincide with each other, depending on the implementation or the intention(s) of the implementer. However, in the detailed description of the present disclosure, for convenience of description, an example configuration will be described in which the rotor axis line and the canister axis line CNX coincide with each other.

A plurality of blades 188 may be on the core 181. The plurality of blades 188 may protrude in the radial direction from the outer circumferential surface of the core 181, and may be at equal angular intervals around the canister axis line CNX.

Because the canister 160 is supported by the cassette frame 101 at an angle such that the rear end 166 is lower than the front end 164, the medicine in the internal space 161 may move backward by gravity between a pair of adjacent blades 188.

A plurality of units of the medicine may be between a pair of adjacent blades 188 in a direction parallel to the canister axis line CNX, but only one unit of the medicine may be between each pair of adjacent blades 188 in a circumferential or radial direction around the canister axis line CNX.

The discharge hole 167 may be above the canister axis line CNX at the rear end 166 of the canister 160. When the rotor 180 rotates, the medicine between a pair of adjacent blades 188 eventually aligns with the discharge hole 167, and the medicine is discharged by gravity to the outside of the canister 160, specifically, toward the lower rear, through the discharge hole 167.

As the rotor 180 rotates, after one unit of the medicine is discharged through the discharge hole 167, the next unit of the medicine may be aligned with the discharge hole 167 and then discharged through the discharge hole 167. Another unit of the medicine in the internal space 161 may move between the pair of blades 188 from which the previous unit of medicine has been discharged.

A motor connection through-hole 169 is at the rear end 166 of the canister 160 and is open, such that the connecting shaft portion 185 protrudes toward the rear of the canister 160 (e.g., through the motor connection through-hole 169). The canister 160 includes a rotor stopper 168 around the motor connection through-hole 169 to block the medicine between the core 181 and the blade 188 of the rotor 180 from escaping from the canister 160.

The medicine supply module 100 may further include a fastener 189 to be fastened to the connecting shaft portion 185 to prevent the rotor 180 from swinging in a direction parallel to the canister axis line CNX inside the canister 160. The fastener 189 may comprise a C-ring (e.g., having the shape of the letter ‘C’). A stepped C-ring fastening groove portion 187 may be on the outer circumferential surface of the connecting shaft portion 185 to secure the fastener 189.

Depending on the size and shape of the medicine in the canister 160, different types of rotors may be substituted in the canister 160 (e.g., for the rotor 180 shown in the drawings). The type of the rotor 180 may vary depending on, for example, the intervals between the blades 188, the length of the blades 188, the thickness of the blades 188, the width of the blades 188, etc. In addition, the rotor 180 may have blades 188 that are reversibly detachable from the core 181, and different types of blades 188 may be coupled to the core 181 depending on the size and shape of the medicine in the canister 160.

The electric motor 210 provides power to rotate the rotor 180. The electric motor 210 includes a motor shaft 212 that protrudes forward along the canister axis line CNX. The motor shaft 212 and the connecting shaft portion 185 of the rotor 180 may be coaxially connected to each other to enable power transmission.

For example, a concave spline groove portion having a concave spline pattern on the inner surface thereof may be in the connecting shaft portion 185, a convex spline ring 214 having a convex spline pattern on the outer surface thereof may be coaxially fixed to or integrated onto the motor shaft 212, and the convex spline ring 214 may fit into or be complementary to the concave spline groove portion. Accordingly, when the motor shaft 212 rotates, the rotor 180 may rotate around the canister axis line CNX.

The electric motor 210 may comprise, for example, an alternating-current (AC) synchronous motor or a direct-current (DC) motor. When the electric motor 210 is an AC synchronous motor, when an excessive load is applied to the motor shaft 212 rotating in one direction, the motor shaft 212 may automatically rotate in the opposite direction. Thus, when the medicine is caught or stalled between the discharge hole 167 or the blade 188 and the inner surface of the canister 160, the rotor 180 may rotate in the opposite direction to relieve the stall of the rotor 180 caused by the medicine and suppress damage to the rotor 180, the motor 210 and/or the medicine.

The cassette frame 101 supports one or more canisters 160 at an angle such that one side or end of the canister 160 is lower than another side or end. In detail, the canister(s) 160 may be detachably coupled to or mounted on or in the cassette frame 101 such that the rear end 166 is lower than the front end 164.

The cassette frame 101 includes an outer box portion 102 and an inner barrel portion 140 that are integral with each other. The outer box portion 102 may include a front surface 103, outer side surfaces 110, 120, 130, and 135, coupling rail portions 124 and 136, and coupling groove portions 114 and 131. The front surface 103 may be substantially planar and have a rectangular shape. An inlet 105 into which a canister 160 is inserted may be on the front surface 103 and may correspond to the shape of the canister 160.

The outer side surfaces 110, 120, 130, and 135 may be bent or curved at outer peripheral edges of the front surface 103, and then extend backward and/or downward. The outer side surfaces 110, 120, 130, and 135 may include an upper side surface 110, a lower side surface 120, a left side surface 130, and a right side surface 135. The upper side surface 110 and the lower side surface 120 may be substantially planar and have a rectangular shape. The left side surface 130 and the right side surface 135 may be substantially planar and have a parallelogrammatic shape. Accordingly, in the cross-sectional view of FIG. 2, the surface of the cassette frame 101 opposite from the front surface 103 is not at a right angle to the canister axis line CNX and faces the rear frame 13, and thus, the cassette frame 101 is inclined (e.g., relative to a horizontal plane).

Because the plurality of medicine supply modules 100 are in a matrix, a plurality of cassette frames 101 are also in a corresponding matrix. The cassette frame 101 of an arbitrary medicine supply module 100 may be detachably coupled to the cassette frame 101 of another medicine supply module 100 adjacent to the arbitrary medicine supply module 100.

At this time, the outer side surfaces 110, 120, 130, and 135 of the cassette frame 101 of the arbitrary medicine supply module 100 may face and come into contact with one of the outer side surfaces 110, 120, 130, and 135 of the cassette frame 101 of another medicine supply module 100 adjacent to the arbitrary medicine supply module 100.

For example, the upper side surface 110 of the arbitrary cassette frame 101 may face and contact the lower side surface 120 of the adjacent cassette frame 101 above the arbitrary cassette frame 101, and the lower side surface 120 of the arbitrary cassette frame 101 may face and contact the upper side surface 110 of the adjacent cassette frame 101 below the arbitrary cassette frame 101. In addition, the left side surface 130 of the arbitrary cassette frame 101 may face and contact the right side surface 135 of the adjacent cassette frame 101 to the left of the arbitrary cassette frame 101, and the right side surface 135 of the arbitrary cassette frame 101 may face and contact the left side surface 130 of the adjacent cassette frame 101 to the right of the arbitrary cassette frame 101. In addition, openings may be in the surfaces 110, 120, 130, and 135, in which case, providing convenience to an operator during assembly or maintenance.

An arbitrary cassette frame 101 may be detachably coupled to one or more other cassette frames 101 adjacent to the arbitrary cassette frame 101 by one or more of the coupling rail portions 124 and 136 and one or more of the coupling groove portions 114 and 131. The coupling rail portions 124 and 136 may protrude from the outer side surfaces 120 and 135 and extend along straight paths in the forward and backward directions.

The coupling groove portions 114 and 131 is concavely recessed from the outer side surfaces 110 and 130 and extends along straight paths in the forward and backward directions. The coupling rail portions 124 and 136 of an arbitrary cassette frame 101 may fit into and couple to the coupling groove portions 114 and 131 of the adjacent cassette frame(s) 101.

The coupling rail portions 124 and 136 may include first T-shaped rails 125 and 137, and second T-shaped rails 126 and 138, respectively, which have a cross section in the shape of ‘T’. The first T-shaped rails 125 and 137 and the second T-shaped rails 126 and 138 may extend along straight paths. The first T-shaped rails 125 and 137 and the second T-shaped rails 126 and 138 may be spaced apart from each other such that gaps 127 and 139 are formed therebetween, respectively.

The coupling groove portions 114 and 131 may include T-shaped elongated grooves or slots 115 and 132 recessed to have a cross section in the shape of ‘T’, and locking protrusions 116 and 133 that narrow the T-shaped elongated grooves 115 and 132 at positions corresponding to the gaps 127 and 139 in the coupling rail portions 124 and 136, respectively. The T-shaped elongated grooves 115 and 132 may be open toward the front surface 103.

The medicine supply module 100 may be installed in the medicine cabinet 11 and the rear frame 13 by pushing an arbitrary cassette frame 101 from the front to the rear such that the coupling rail portion(s) 124 of the arbitrary cassette frame 101 engage with the corresponding coupling groove portion(s) 114 of a first adjacent cassette frame 101, and the coupling rail portion 136 of the arbitrary cassette frame 101 engages with the corresponding coupling groove portion 131 of a second adjacent cassette frame 101 when present. When installing additional medicine supply modules 100 later, the coupling groove portion(s) 114 of the arbitrary cassette frame 101 engage with the corresponding coupling rail portion(s) 124 of a third adjacent cassette frame 101, and the coupling groove portion 131 engages with the corresponding coupling rail portion 136 of a fourth adjacent cassette frame 101, respectively.

The medicine supply modules 100 may be supported by the rear frame 13, and the rear end of the cassette frame 101 or a discharge guide 190 to be described below may be detachably coupled to the rear frame 13. When the cassette frame 101 is pushed in until the medicine supply module 100 is coupled to the rear frame 13, the locking protrusions 116 and 133 are positioned in the corresponding gaps 127 and 139, respectively. Thus, an accident in which the cassette frame 101 is unintentionally separated from the adjacent cassette frame 101 and moves forward may be prevented.

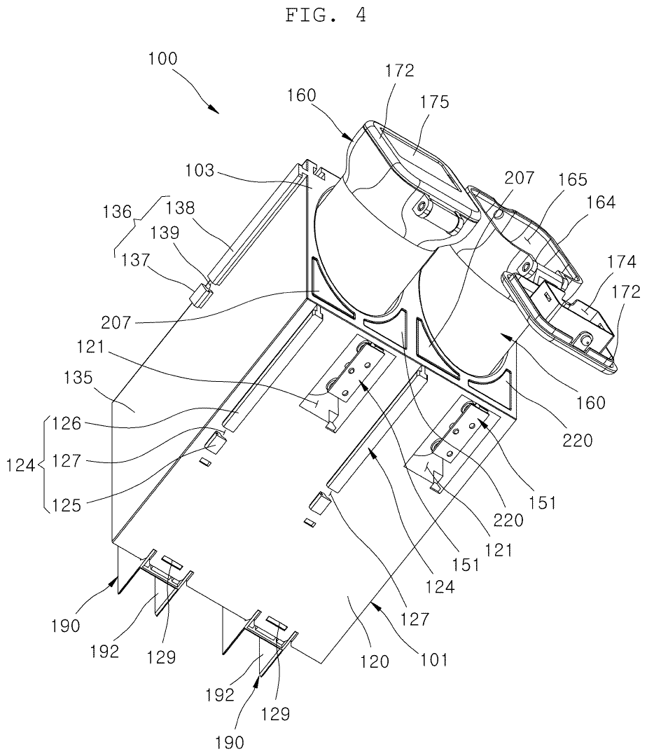

FIGS. 3 and 4 illustrate the cassette frame 101 in which the coupling rail portions 124 and 136 are on the lower side surface 120 and the right side surface 135, and the coupling groove portions 114 and 131 are in the upper side surface 110 and the left side surface 131, respectively, but this is merely an example, and it is obvious that the present disclosure is not limited to the shapes and positions of the coupling rail portions 124 and 136 and the coupling groove portions 114 and 131 illustrated in FIGS. 3 and 4. For example, the cassette frames 101 may be integral with each other, or may matingly connect or assemble to each other vertically and/or horizontally using one or more pressure-fit connectors (e.g., similar to Lego bricks).

Alternatively, when the cassette frame 101 has a certain protruding surface portion (not shown) on one side or surface thereof, the protruding surface portion may function as a coupling rail portion 124 and/or 136, and a groove portion having a shape corresponding (e.g., complementary) to the shape of the protruding surface portion may be on the side surface of an adjacent cassette frame 101 that corresponds to the protruding surface portion, to function as the coupling groove portions 114 and 131 such that the groove portion is coupled to the protruding surface portion.

The inner barrel portion 140 has a roughly cylindrical shape. When inserting the canister 160 into the cassette frame 101, the canister 160 that has entered through the inlet 105 of the front surface 103 may slide along an inner surface 141 of the inner barrel portion 140, and thus be inserted into the cassette frame 101. On the contrary, when withdrawing the canister 160 from the cassette frame 101, the canister 160 may slide along the inner surface 141 of the inner barrel portion 140 to be removed from the cassette frame 101 through the inlet 105 at the front surface 103.

A rear end 146 of the inner barrel portion 140 may block the canister 160 from entering further into the cassette frame 101. A discharge hole 148 may be aligned with the discharge hole 167 of the canister 160, and a motor connection through-hole 147 may be aligned with the motor connection through-hole 169 of the canister 160 at the rear end 146 of the inner barrel portion 140.

The medicine may be discharged outside of the cassette frame 101 through the discharge hole 167 of the canister 160 and the discharge hole 148 of the inner barrel portion 140. The motor shaft 212 may be coaxially connected to the connecting shaft portion 185 of the rotor 180 through the motor connection through-hole 169 of the canister 160 and the motor connection through-hole 147 of the inner barrel portion 140.

In order for the canister 160 to be detachably coupled to the cassette frame 101, one of the cassette frame 101 and the canister 160 may include an elastic hook 143, and the other of the cassette frame 101 and the canister 160 may include an interference protrusion 170 to interfere or engage with (e.g., clasp) the elastic hook 143.

For example, the cassette frame 101 may include the elastic hook 143 at the front end of the inner barrel portion 140, and the canister 160 may include the interference protrusion 170 on the outer surface thereof. The inlet 105 of the front surface 103 may be configured (e.g., have a shape and/or size) such that insertion and withdrawal of the interference protrusion 170 are not hindered.

The user may remove the canister 160 from the cassette frame 101 by pushing the interference protrusion 170 forward or by pulling the canister 160 forward. An elongated groove 111 extending in the forward and backward directions may be on the upper side surface 110 of the outer box portion 102 such that the user's hand may access the interference protrusion 170, which may be partially or completely blocked by the elastic hook 143.

As illustrated in FIGS. 3 and 4, a pair of canisters 160 may be inserted in, coupled to and/or supported by the cassette frame 101. However, unlike in FIGS. 3 and 4, one canister may couple to and be supported by one cassette frame, or three or more canisters may couple to and be supported by the one cassette frame. In addition, a plurality of canisters 160 may couple to and be supported by a cassette frame structure having an N×M matrix structure (where N and M are positive integers).

An inclination angle AN1 (hereinafter, referred to as the ‘canister inclination angle’) between the canister axis line CNX extending in the lengthwise direction of the canister 160 and a horizontal line or plane PL may be about 30° to 40°. An inclination angle AN2 (hereinafter, referred to as the ‘cassette frame inclination angle’) of the outer side surfaces 110, 120, 130, and 135 of the cassette frame 101 with respect to the horizontal line or plane PL may be equal to the canister inclination angle AN1.

When the inclination angles AN1 and AN2 are less than about 30° and a small or light medicine is in the internal space 161 of the canister 160, the force of gravity on the medicine may be insufficient (e.g., to overcome frictional forces between the medicine and the wall of the canister 160), and thus, the medicine may not be seamlessly discharged outside of the cassette frame 101 through the discharge holes 167 and 148 of the canister 160 and the cassette frame 101.

When the inclination angles AN1 and AN2 are greater than about 40°, it may be difficult to install the cassette frame 101 of the medicine supply module 100 in the medicine cabinet 11 and/or couple it to an adjacent cassette frame 101, or to remove the cassette frame 101 of the medicine supply module 100 from the medicine cabinet 11. In addition, it may be inconvenient to replenish the internal space 161 with medicine units through the insertion hole 165 when the canister 160 is coupled to the cassette frame 101 and the inclination angles AN1 and AN2 are outside the range of 30-40°. In addition, when the inclination angles AN1 and AN2 are greater than about 40°, the vertical height and/or the horizontal depth of the medicine cabinet 11 may increase.

When the inclination angles AN1 and AN2 are about 30° to 40°, a space having an approximately triangular cross-section extending in one or more horizontal directions is below the lowermost medicine supply modules 100, and this space may reduce the space that the plurality of multi-type medicine supply devices 20 occupy. Thus, it is possible to design a compact medicine packing apparatus 10 including a plurality of medicine supply modules 100 and a plurality of multi-type medicine supply devices 20 while having a reduced height in the vertical direction.

The medicine supply module 100 may further include the discharge guide 190, remaining quantity detection sensors 151 and 156, a circuit board 200, and a state display unit 205. The discharge guide 190 may guide the medicine discharged from the discharge holes 167 and 148 of the canister 160 and the inner barrel portion 140 toward the hopper 30. The discharge guide 190 may be coupled to the cassette frame 101 and have a medicine path in communication with the discharge holes 167 and 148 of the canister 160 and the inner barrel portion 140.

For example, the discharge guide 190 may include a drop channel 192 extending vertically and optionally inclined toward the rear, and a medicine entry portion 191 in communication with the upper end of the drop channel 192. The medicine discharged from the discharge holes 167 and 148 of the canister 160 and the inner barrel portion 140 enters the discharge guide 190 through the medicine entry portion 191 having an opening therein, and falls downward along the drop channel 192, which may have a slide shape.

The discharge guide 190 further includes an upper coupling hook 195 and a lower coupling hook 196. The upper coupling hook 195 may fit detachably into an upper hook through-hole 119 at the rear end of the upper side surface 110 of the cassette frame 101, and the lower coupling hook 196 may fit detachably into a lower hook through-hole 129 at the rear end of the lower side surface 120 of the cassette frame 101. With this configuration, the discharge guide 190 may be coupled to the cassette frame 101.

The remaining quantity detection sensors 151 and 156 detect the quantity of the medicine remaining in the internal space 161. The remaining quantity detection sensors 151 and 156 may include a first sensor 151 and a second sensor 156 that are fixed to and/or supported by the inner barrel portion 140, and which may face each other.

The first sensor 151 may include a first sensor light source 153 that emits light S1 toward the second sensor 156, a first light-receiving element 154 on which light S2 emitted from the second sensor 156 is incident, and a first sensor circuit board 152 on which the first sensor light source 153 and the first light-receiving element 154 are mounted.

The second sensor 156 may include a second light-receiving element 158 on which the light S1 emitted from the first sensor 151 is incident, a second sensor light source 159 that emits the light S2 toward the first sensor 151, and a second sensor circuit board 157 on which the second light-receiving element 158 and the second sensor light source 159 are mounted. The first sensor circuit board 152 and the second sensor circuit board 157 may be fixedly installed on the inner barrel portion 140 to face each other.

The first sensor light source 153 and the second sensor light source 159 may project, for example, infrared (IR) light. The first sensor light source 153 and the second light-receiving element 158 may face each other such that the light S1 emitted from the first sensor light source 153 may be incident on the second light-receiving element 158. In addition, the second sensor light source 159 and the first light-receiving element 154 may face each other such that the light S2 emitted from the second sensor light source 159 may be incident on the first light-receiving element 154.

When the light S1 projected from the first sensor light source 153 is incident on the second light-receiving element 158, the second light-receiving element 158 may generate a detection signal corresponding to the light S1 (e.g., its presence or absence). When the light S2 projected from the second sensor light source 159 is incident on the first light-receiving element 154, the first light-receiving element 154 may generate a detection signal corresponding to the light S2 (e.g., having a state indicating the presence of the light at the light-receiving element 154). Unless the light S1 projected from the first sensor light source 153 is blocked by the medicine in the internal space 161, the light S1 may be incident on the second light-receiving element 158. Likewise, unless the light S2 projected from the second sensor light source 159 is blocked by the medicine in the internal space 161, the light S2 may be incident on the first light-receiving element 154.

The first sensor 151 and the second sensor 156 may be the same or the same type. In detail, the remaining quantity detection sensors 151 and 156 may be in the canister 160, each including a sensor light source, a light-receiving element, and a sensor circuit board, and one of the pair of sensors is in the canister 160 such that the sensor light source faces the front end 164 of the canister 160 and the light-receiving element faces the rear end 166 of the canister 160, and the other sensor is in the canister 160 such that the light-receiving element faces the front end 164 of the canister 160 and the sensor light source faces the rear end 166 of the canister 160.

The canister 160 may comprise a transparent material to allow the light S1 and the light S2 to easily pass therethrough. The user may access the first sensor 151 through a groove or opening 121 on the lower side surface 120. The user may access the second sensor 156 through the elongated groove or opening 111 on the upper side surface 110.

The first sensor light source 153 is positioned closer to the rear end 166 of the canister 160 than the second sensor light source 159, and the second light-receiving element 158 is positioned closer to the rear end 166 of the canister 160 than the first light-receiving element 154.

When the size of the medicine in the internal space 161 is large, the light S1 projected from the first sensor light source 153 may not be incident on the second light-receiving element 158, and thus, no corresponding detection signal may be generated, whereas the light S2 projected from the second sensor light source 159 may be incident on the first light-receiving element 154, and thus, a corresponding detection signal may be generated. In this case, a message indicating that the quantity of medicine remaining in the internal space 161 is insufficient and thus replenishment of medicine is necessary may be displayed on a monitor (not shown) of the medicine packing apparatus 10.

When the size of the medicine accommodated in the internal space 161 is small, the light S1 projected from the first sensor light source 153 may be incident on the second light-receiving element 158, and thus, a corresponding detection signal may be generated. The light S2 projected from the second sensor light source 159 may also be incident on the first light-receiving element 154, and thus, a corresponding detection signal may also be generated. In this case, a message indicating that the quantity of medicine remaining in the internal space 161 is insufficient and thus replenishment of medicine is necessary may be displayed on the monitor of the medicine packing apparatus 10.

Meanwhile, the light S1 and the light S2 projected respectively from the first sensor light source 153 and the second sensor light source 159 are not limited to IR light, and other types of light, such as laser or visible light, may also be projected.

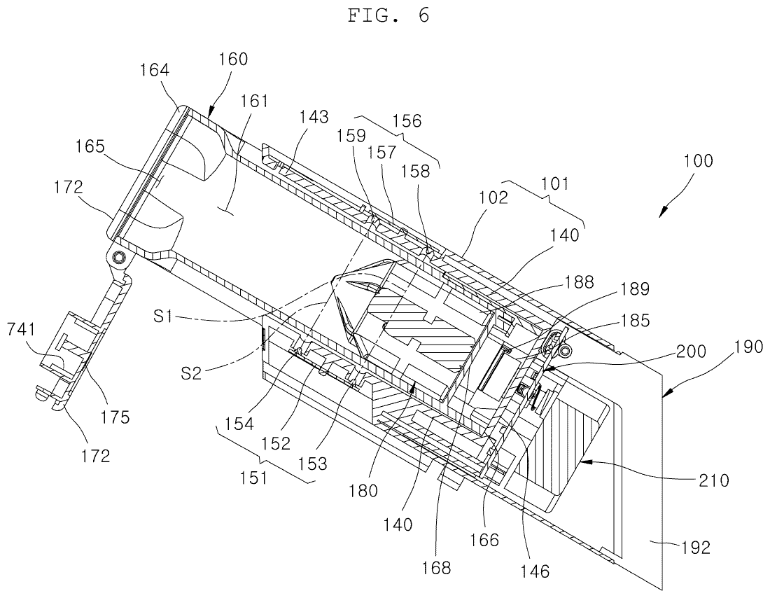

In addition, the medicine supply module 100 according to the embodiment illustrated in FIG. 6 includes a pair of sensor light sources 153 and 159 and a pair of light-receiving elements 154 and 158, but this is exemplary, and the medicine supply module 100 according to the present disclosure may include one sensor light source and one light-receiving element, or may include three or more sensor light sources and three or more light-receiving elements.

The circuit board 200 may supply power and a control signal for controlling the electric motor 210. The electric motor 210 may be supported by the cassette frame 101 via the circuit board 200. In detail, the electric motor 210 may be coupled to the circuit board 200, and the circuit board 200 may be fixed to and/or supported by the rear end 146 of the inner barrel portion 140.

A medicine discharge penetration groove portion 203 aligned with the discharge hole 148 at the rear end 146 of the inner barrel portion 140, and a motor shaft penetration groove portion 201 that is open to allow the motor shaft 212 to pass therethrough, may be in the circuit board 200.

The state display unit 205 displays a signal (e.g., by projecting light) indicating an operation state of the medicine supply module 100 that is visible from the front of the medicine supply module 100. The state display unit 205 may include a light source 206 and a light guide member 207. The light source 206 may comprise, for example, a light-emitting diode (LED) capable of projecting visible light having one or more of various colors. The light source 206 may be mounted on the circuit board 200.

The light guide member 207 guides light projected from the light source 206 forward through the front surface 103. The light guide member 207 may penetrate the cassette frame 101 in the forward direction and optionally in the backward direction. The front surface of the light guide member 207 may be exposed to the front surface 103 of the cassette frame 101, and the rear surface of the light guide member 207 may face the light source 206.

The color or blinking pattern of the light projected from the light source 206 may change according to the operational state of the medicine supply module 100. Meanwhile, the medicine supply module according to another embodiment of the present disclosure may include a state display unit 205 that does not include a light guide member. In this case, the canister 160 may function as a light guide member. In detail, the light source may project light onto the rear end 166 of the canister 160, and the light incident on the rear end 166 of the canister 160 may be reflected forward through the front end 164 of the canister 160 and be visible from the front of the medicine supply module 100.

The label attachment surface 175 to which a label (not shown) may be attached may be on the front surface of the cassette frame 101, wherein the label has written thereon indications such as a number or name uniquely assigned to a specific medicine supply module 100 among the plurality of medicine supply modules 100.

The medicine supply module 100 may include a pair of rotors 180, a pair of electric motors 210, a pair of remaining quantity detection sensors 151 and 156, and a pair of state display units 205, all corresponding to the pair of canisters 160. The medicine supply module 100 of the present disclosure may include the same number of canisters 160, rotors 180, electric motors 210, remaining quantity detection sensors 151 and 156, and state display units 205.

The medicine supply module 100 is configured such that the user may open the cap 172 and insert a medicine into the canister 160 through the insertion hole 165 while the canister 160 is coupled to and supported by the cassette frame 101. As such, even during the operation of the medicine packing apparatus 10, the cap 172 may be opened without stopping the operation and the canister 160 may be supplied and replenished with a medicine. Thus, the medicine supply module 100 and the medicine packing apparatus 10 of the present disclosure may improve the productivity of medicine packing tasks.

In the medicine supply module 100 described above, the canister 160 may move in the inclination direction to be coupled to and detached from the cassette frame 101, and the cassette frame 101 is detachably coupled to one or more other cassette frames 101 of adjacent medicine supply modules 100. Thus, the vertical height and the horizontal width of the medicine packing apparatus 10 including a plurality of medicine supply modules 100 in a matrix may be easily reduced in the same occupied area or space compared to a conventional medicine packing apparatus.

In other words, compared to a conventional medicine packing apparatus with the same number of types of medicines to be automatically supplied, the medicine packing apparatus of the present disclosure may be more compact, enabling installation in a smaller space.

Although the present disclosure has been described with reference to the embodiments illustrated in the drawings, they are merely exemplary, and those skilled in the art will understand that various modifications and equivalent embodiments may be made therefrom. Therefore, the scope of the present disclosure should be defined only by the following claims.

What is claimed is:

1. A medicine supply module comprising:
a canister having an internal space adapted to accommodate a medicine, an insertion hole through which the medicine enters the internal space, and a discharge hole through which the medicine is discharged from the internal space, the insertion hole being on a first side of the canister, and the discharge hole being on a second side of the canister opposite from the first side;
a rotor in the internal space configured to rotate and discharge the medicine one tablet at a time through the discharge hole;
a cassette frame that supports the canister at an angle such that the second side of the canister is lower than the first side of the canister; and
an electric motor that provides power to rotate the rotor and is supported by the cassette frame.

2. The medicine supply module of claim 1, wherein the canister has an axis line along its length, and the axis line is inclined at an angle of 30° to 40° relative to a horizontal line or plane.

3. The medicine supply module of claim 1, wherein the cassette frame comprises a front surface having an inlet into which the canister fits, and the canister is detachably coupled to the cassette frame.

4. The medicine supply module of claim 1, wherein the canister has a cylindrical shape in part or in whole, and the cassette frame comprises a front surface having an inlet into which the canister fits and having a shape corresponding to the cylindrical shape of the canister.

5. The medicine supply module of claim 1, wherein the cassette frame is attachable and detachable from another cassette frame in another medicine supply module.

6. The medicine supply module of claim 5, wherein the cassette frame comprises:
a front surface having an inlet into which the canister fits;
an outer side surface that extends from an outer peripheral edge of the front surface;
a coupling rail portion protruding from the outer side surface and extending linearly; and
a coupling groove portion that is concavely recessed from the outer side surface and extends linearly, and that mates with a coupling rail portion of an adjacent cassette frame.

7. The medicine supply module of claim 6, wherein the outer side surface is inclined at an inclination angle with respect to a horizontal plane that is equal to an inclination angle between a canister axis line extending in a lengthwise direction of the canister and a horizontal line or the horizontal plane.

8. The medicine supply module of claim 1, wherein the cassette frame supports a plurality of the canisters, and the rotors and the electric motors are in a one-to-one correspondence with the plurality of canisters.

9. The medicine supply module of claim 1, further comprising a remaining quantity detection sensor configured to detect a quantity of the medicine remaining in the internal space.

10. The medicine supply module of claim 1, further comprising a state display unit configured to project light indicating a state of the medicine supply module that is visible from the front of the medicine supply module.

11. The medicine supply module of claim 1, further comprising a discharge guide that is coupled to the cassette frame and in communication with the discharge hole, configured to guide the medicine discharged from the discharge hole.

12. The medicine supply module of claim 1, wherein the cassette frame has a front surface, an upper side surface, and a lower side surface that are rectangular in shape, a left side surface and a right side surface that are parallelogrammatic in shape, and a rear end that, when coupled to a rear frame that is perpendicular to a horizontal line, inclines a shape of the cassette frame forward and upward.

13. A medicine packing apparatus comprising:
a medicine cabinet comprising a plurality of medicine supply modules of claim 1 in a matrix, and a rear frame that supports the plurality of medicine supply modules; and
a packing unit that packs the medicine discharged from the medicine cabinet on a dose basis.

14. The medicine packing apparatus of claim 13, wherein the cassette frame of each of the plurality of medicine supply modules is detachably coupled to the cassette frame of an adjacent one of the medicine supply modules.

15. The medicine packing apparatus of claim 14, wherein the cassette frame comprises a front surface having an inlet into which the canister fits, and an outer side surface that extends from an outer peripheral edge of the front surface; and the outer side surface of the cassette frame of each of the plurality of medicine supply modules faces and contacts an outer side surface of the cassette frame of the adjacent one of the medicine supply modules.

16. The medicine packing apparatus of claim 13, wherein, during operation, the medicine is inserted into the canister through the insertion hole while the canister is supported by the cassette frame.
